(19) United States
(12) Patent Application Publication
(10) Pub. No.: US 2015/0363478 A1
(43) Pub. Date: Dec. 17, 2015

(54) Systems, Devices, and/or Methods for Managing Data

(71) Applicant: Michael N. Haynes, Keswick, VA (US)

(72) Inventor: Michael N. Haynes, Keswick, VA (US)

(21) Appl. No.: 13/604,694

(22) Filed: Sep. 6, 2012

Related U.S. Application Data
(63) Continuation of application No. 12/500,758, filed on Jul. 10, 2009, now abandoned.
(60) Provisional application No. 61/107,024, filed on Oct. 21, 2008.
(60) Provisional application No. 61/079,965, filed on Jul. 11, 2008.

(51) Int. Cl. G06F 17/30

(52) U.S. Cl. CPC G06F 17/30575; G06F 17/30589; G06F 17/30572; G06F 17/30327

(57) ABSTRACT

Certain exemplary embodiments can provide a system, machine, device, manufacture, circuit, and/or user interface adapted for, and/or a method and/or machine-readable medium comprising machine-implementable instructions for, activities that can comprise: via a hierarchy processor implemented via a predetermined information device: for each of a plurality of records of a data structure, displaying data corresponding to a hierarchically displayable field according to a hierarchy location field containing a corresponding hierarchy location identifier indicative of a display location of that data in a displayable hierarchical data structure.

### CROSS-REFERENCES TO RELATED APPLICATIONS

This application claims priority to, and incorporates by reference herein in its entirety, pending U.S. Provisional Patent Application 61/079,965 (Attorney Docket 1007-021), filed 11 Jul. 2008 and pending United States Provisional Patent Application 61/107,024 (Attorney Docket 1007-022), filed 21 Oct. 2008.

### BRIEF DESCRIPTION OF THE DRAWINGS

A wide variety of potential embodiments will be more readily understood through the following detailed description of certain exemplary embodiments, with reference to the accompanying exemplary drawings in which:

FIG. 1 is an exemplary outline 1000;

FIG. 2 is an exemplary outline 2000;

FIG. 3 is an exemplary outline view 3000;

FIG. 4 is an exemplary outline view 4000;

FIG. 5 is an exemplary list view 5000;

FIG. 6 is an exemplary table view 6000;

FIG. 7 is an exemplary form view 7000;

FIG. 8 is an exemplary column view 8000;

FIG. 9 is a block diagram of an exemplary embodiment of a system 9000;

FIG. 10 is a block diagram of an exemplary embodiment of an information device 10000;

FIG. 11 is a flowchart of an exemplary embodiment of a method 11000;

FIG. 12 is an exemplary column view 12000; and

FIG. 13 is an exemplary column view 13000.

### DETAILED DESCRIPTION

### Hierarchies

A hierarchical structure, such as an outline and/or nested columns, can be used to express a hierarchical organization of a set of records. Taxonomies, or taxonomic schemes, are typically comprised of taxonomic units known as taxa (singular taxon), or kinds of things that can be arranged in a hierarchical structure, typically related by supertype-subtype relationships, also called parent-child relationships.

In a given supertype-subtype relationship, the subtype can be defined to have the same constraints and/or properties as the supertype plus one or more additional constraints and/or properties. That is, the child or subtype in the hierarchy can inherit all of the characteristics of the parent or supertype. This is sometimes referred to as an object-oriented relationship. For example, a motorcycle can be considered to be a subtype of vehicle. So from this taxonomy perspective, any motorcycle is a vehicle, but not every vehicle is necessarily a motorcycle. Therefore, a thing needs to satisfy more constraints and/or possess more properties to be a motorcycle than to be a vehicle.

Almost anything, such as animate objects (e.g., Kingdom, Phylum, Class, Order, Family, Genus, Species, etc.), inanimate objects (e.g., Electronic Device, Component, Circuit, Part, etc.), places (e.g., Country, State, Region, City, Neighborhood, etc.; Building, Section, Aisle, Shelf, Bin, etc.; IP addresses; and/or Drive, Volume, Directory, Folder, File, etc.), concepts (e.g., Law, Regulation, Rule, Procedure, etc.), events (e.g., Era, Period, Year, Date, Actor, etc.), activities (e.g., Goal, Project, Task, Action, etc.), properties (e.g., Muse, Genre, Period, Style, Artist, etc.), and/or relationships (e.g., Entity, Parents, Grandparents, etc.; and/or Director, Managers, Supervisors, Workers, etc.), etc., can be classified according to some taxonomic scheme and/or can be organized and/or rendered according to a hierarchy.

A supertype and/or parent can relate to its subtype and/or child in any of a number of manners. For example, a parent can be more general than the child, more specific than the child, older than the child, younger than the child, etc. Moreover, in certain taxonomies, the parent can represent one attribute, and the child another, which can be somewhat and/or completely independent of the parent's attribute. For example, consider a taxonomy and/or hierarchy for selecting a dog breed, in which the grandparent attribute is Size, the parent attribute is Ease of Training, the child attribute is Energy Level, and the grandchild attribute is one or more specific breeds of dogs.

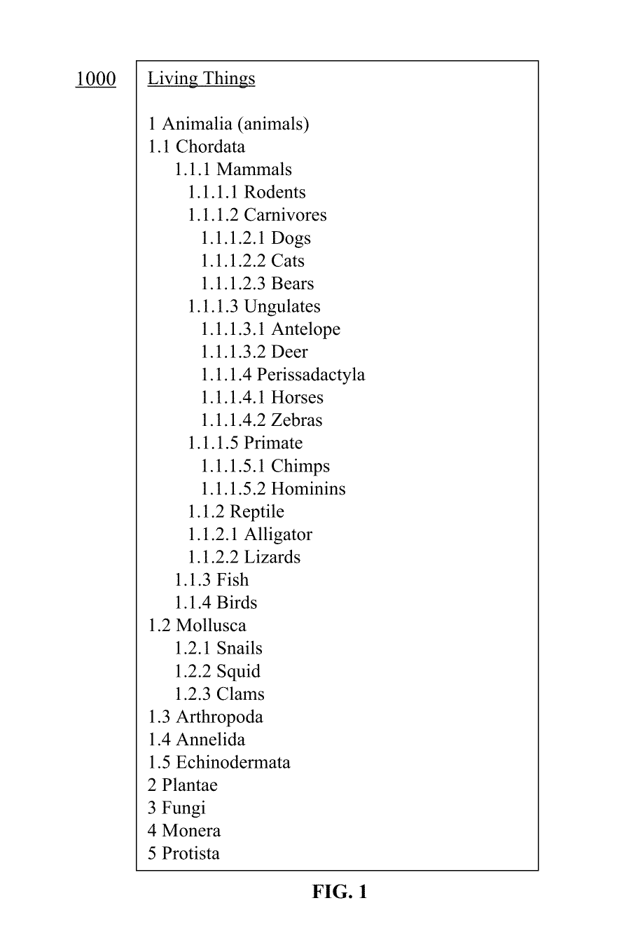

FIG. 1 shows an exemplary set of records (“set”), any portion of which can be organized as a hierarchy and/or rendered as a hierarchically-organized view (“view”) (in this particular case, presented as an outline), for certain living things. Note that because it presents at least a portion of a hierarchy, this particular outline presents a single top level element and/or root node (living things), which has 5 displayed children elements (e.g., animalia, plantae, fungi, etc.), which are displayed as siblings of each other. Some of these children, such as animalia, have displayed children of their own. Animalia, has many displayed descendants, including primates and hominins (humans). Although each of these descendants has a single parent, some have many ancestors (e.g., for humans, the displayed ancestors are animalia, chordata, mammals, and primates).

From a general organizational perspective, each element of a hierarchy can be uniquely characterized and/or identified by a combination of the hierarchical level and/or layer it occupies, and its rank and/or position within that level. For example, referring to FIG. 1, hominins can be uniquely identified within this particular outline, view, and/or set by the identifier 1.1.1.5.2, which indicates that this element is the element 2 of the fifth layer, of element 5 (primate) of the fourth layer, of element 1 (mammals) of the third layer, of element 1 of the second layer, of element 1 of the first layer. Note that the elements of a given level of a hierarchy can be ranked and/or ordered in any manner, such as, for example, from general to specific, specific to general, broader to narrower, narrower to broader, older to newer, newer to older, attribute 1 to attribute 2, user-selected, programmatically, automatically, manually, randomly, etc.

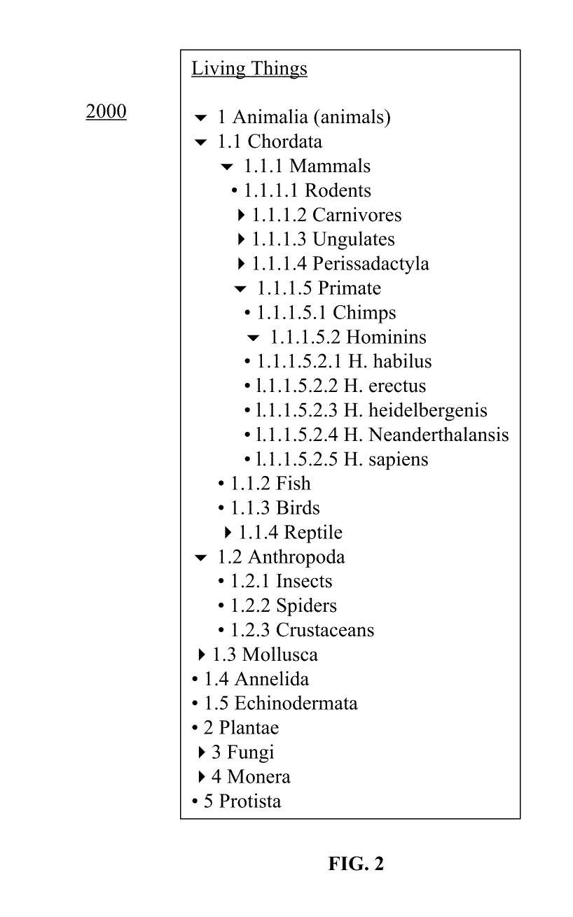

Generally, elements can be moved and/or rearranged within a hierarchy. For example, in FIG. 2, with respect to FIG. 1, Arthropoda has been moved above Mollusca, and their element numbering reflects this movement and/or change in hierarchical position. That is, arthropoda was labeled as 1.3 in FIG. 1, and is labeled 1.2 in FIG. 2.

FIG. 2 also shows that, via certain exemplary embodiments, elements can be expanded or collapsed to show or hide their descendants. For example, Arthropoda has been expanded to display its children (e.g., Insects, Spiders, Crustaceans). As another example, Carnivores (1.1.1.2) has been collapsed to hide the display of Dogs (1.1.1.2.1 in FIG. 1). Symbols (e.g., [symbol] , [symbol] , [symbol] , [symbol] [symbol] , [symbol] , [symbol] [symbol] , [symbol] , etc.), such as the bullets and/or rightward pointing and downward pointing triangles of FIG. 2, can indicate whether a given element has children and/or whether those children are displayed or hidden.

### Hierarchy Processor

Certain exemplary embodiments can provide systems, devices, and/or methods for managing data, such as via a hierarchy processor that can be user-programmable, networkable, server-deployable, web-deployable, web-accessible, browser-compatible, SQL table-connectable, ODBC-compatible, securable, multi-user, cross-platform, object-oriented, and/or relational. In certain exemplary embodiments, the hierarchy processor can be designed to automatically work in conjunction with a relational and/or object-oriented database management system such as FileMaker Pro 9, FileMaker Pro 9 Advanced, FileMaker Server 9, and/or FileMaker Server 9 Advanced from FileMaker Inc. of Santa Clara, Calif.; Access, Microsoft Visual Foxpro, and/or Microsoft SQL Server from Microsoft of Redmond, Wash.; Oracle from Oracle, Corporation of Redwood City, Calif.; DB2 from IBM of Armonk, N.Y.; Informix; Ingres; Sybase; MySQL; SQLite; and/or PostgreSQL; etc. For example, the hierarchy processor can be implemented via at least one script, custom function, and/or external plug-in for FileMaker, a macro and/or VBA module for Access, a database option and/or tool for Oracle; and/or a script for DB2; etc. The hierarchy processor can have and/or rely on one or more of its own user-programmable, user-modifiable, and/or user-selectable database files, tables, fields, table occurrences, relationships, external data sources, formulas, calculations, layouts, views, reports, portals, buttons, icons, tooltips, links, keyboard equivalents, scripts, custom functions, plug-ins, extensions, macros, subroutines, libraries, code, controls, settings, preferences, options, tools, value lists, menus, accounts, custom access privileges and/or permissions, etc.

Certain exemplary embodiments can provide an hierarchy processor that can automatically and/or allow a user to:
define and/or specify one or more sets of records upon which to operate;
view records, from one or more of its user-selectable tables and/or one or more user-selectable tables of user-selectable databases, in any number of user-selectable views, such as a hierarchical outline view, hierarchical column view, tree view, node-link diagram view, nested set view, layered icicle view, list view, free-form view, and/or tabular view, etc. (e.g., allow a user to view multiple copies of the same set, outline, and/or view and/or multiple related and/or unrelated sets, outlines, and/or other views simultaneously);
see and/or access, in a default and/or user-selectable hierarchical view, the data of a user-selectable field of a user-selectable group of records of a user-selectable table of a user-selectable database, that data potentially accompanied by data of related user-selectable fields from those records and/or records of a related user-selectable table and/or database file;
via a hierarchical view of a given hierarchy, position one or more records of the set as desired within that hierarchy;
select a record in one view, and have that record and/or any related record (such as ancestors, siblings, descendants, records at the same and/or user selectable levels, and/or records from the same found set, etc.) be indicated, in one or more other user-selectable views, such as via a user-selectable highlighting, text formatting, symbol, etc.;
modify any layout on which data is displayed;
add, modify, and/or delete a user-selectable record displayed via any layout, such as at any user-selected location in a hierarchical view;
synchronize additions, modifications, and/or deletions of a user-selectable record displayed via any layout, such as at any user-selected location in a hierarchical view with any source database from which any portion of those records originate and/or are stored, potentially reconciling and/or mediating as needed (possibly by requesting human intervention) any additions, modifications, and/or deletions caused by one user during a time of disconnection from that source database with those caused by another user connected to that source database during that same time;
flag, such as for user review, all and/or any user-selectable portion of those unreviewed auto-synchronized records that have been added, modified, deleted, and/or repositioned;
import and/or export data associated with any user-selectable field of any user-selectable record of any user-selectable table of any user-selectable file, such as in a file format compatible with an outliner program, word processor, and/or spreadsheet, etc.;
upon linking a hierarchical view to an external data source, such as one or more fields of one or more tables of one or more databases and/or data files, automatically create header records in a hierarchy and/or set, those header records potentially selected in a manner corresponding to the structure, field names, and/or data of that external data source and/or according to one or more user-selectable rules.
upon linking a hierarchical view to an external data source, such as one or more fields of one or more tables of one or more databases and/or data files, automatically position all and/or a user-programmable filtered selection of records of that external data source within a hierarchy and/or under appropriate headers in that hierarchy, such as according to one or more user-selectable and/or user-programmable rules, such as matching and/or falling within one or more attributes and/or header contents, etc., and/or sorted, such as chronologically, alphabetically, ascending, descending, and/or per a user-customized algorithm, etc., any of which rules can be applied per and/or to any attribute, field, and/or hierarchical level, etc.
via a hierarchical view, such as a hierarchical outline view and/or a hierarchical column view, move (such as via keyboard shortcut and/or click and drag, etc.) a user-selectable record (and potentially all records that descend from that record within the hierarchy and/or set) to nearly any user-selectable location within the hierarchy and/or set;
within a hierarchical view, such as a hierarchical outline view and/or a hierarchical column view, upon revision of a record in and/or related to the corresponding hierarchy and/or set, automatically move that record (and potentially all records that descend from that record within the hierarchy and/or set) to nearly any user-programmable location within the hierarchy and/or set;
from the perspective of a hierarchical view, expand and/or automatically expand a user-selectable record to view some and/or all records that descend from that record;
from the perspective of a hierarchical view, collapse and/or automatically collapse a user-selectable record to hide some and/or all records that descend from that record;
view a user-selectable record (and potentially all records that descend from that record) in a new hierarchical view and/or window dedicated to that record (and potentially its hierarchically descendant records);
specify a labeling scheme for one or more records in a hierarchy and/or set, the labeling scheme applicable to a selected record and/or any related records, such as records that are related as ancestors, siblings, direct children, all descendants, at the same level, and/or at one or more other levels, in the same set, etc., with respect to a selected record;
specify formatting of data (e.g., text formatting (e.g., bold, italics, strikethrough, subscript, color, etc.), numerical formatting (e.g., thousands separator style, number of digits to right of decimal point, handling of negative values, etc.), date formatting, graphical formatting (e.g., highlighting, borders, background color, etc.), etc.) associated with any user-selectable field of any number of user-selectable records and/or any related records, such as records that are related as ancestors, siblings, direct children, all descendants, at the same level, and/or at one or more other levels, in the same set, etc., with respect to a selected record;
specify validation requirements (e.g., require values within a predetermined range and/or from a predetermined list, require predetermined number of characters, require absence of predetermined characters, etc.) for data associated with any user-selectable field of any number of user-selectable records and/or any related records, such as records that are related as ancestors, siblings, direct children, all descendants, at the same level, and/or at one or more other levels, in the same set, etc., with respect to a selected record;
filter and/or perform a search within the records of a given view and/or set, and present the resulting search results and/or filtered records in a non-hierarchical view (e.g., list view, free-form view, tabular view, etc.) without disturbing the hierarchy indicators of those records, so that the full hierarchical set can be restored at any time;
sort the results of a search and/or filtered records for display in a non-hierarchical view without disturbing the hierarchy indicators of those records, so that the full hierarchical set can be restored at any time;
specify, modify, and/or activate a hot link to navigate to, access, select, copy, modify, delete, run, and/or open any desired and/or addressable data, record, set of records, database view, database, web page, and/or electronic file, document, code, script, macro, component, control, widget, application, applet, and/or program, etc. (e.g., audio (e.g., MP3) file, video (e.g., QuickTime, MPEG, etc.) file, PDF document, word processing document, spreadsheet, PowerPoint file, XML file, Flash presentation, AppleScript script, VBA code, Visual Basic component, ActiveX control, DLL file, executable code, QuicKey macro, JavaScript, C++ code, Perl script, Automator workflow, etc.), such as a hot link directed to an addressable: specific script and/or program; specific data of specific field of any and/or a specific record in a specific table of a specific database via a specific layout and/or view; specific cell and/or macro of a specific spreadsheet; specific e-mail message and/or related group of messages; specific event in an calendar program; specific phone number of a specific contact in a contact management program; and/or specific character in a word processing document; etc.;
specify, modify, and/or activate a pre-script and/or post-script associated with a hotlink, such that, for example, a pre-script (which can be any form of software) can be implemented that determines an address for the hotlink, and/or after activation of the hotlink, a post-script (which can be any form of software) can be implemented that performs further processing at the destination of the hotlink;
etc.

Via certain exemplary embodiments, an hierarchy processor can provide:
a “member” table containing one or more member records, each containing a user-selectable hierarchically-organizable and/or hierarchically-presentable member field and/or a corresponding serially-numbered member identifier field, such that the member field, which can contain the data to be hierarchically organized, can be referenced via its identifier field;
an “set” table containing one or more records, each containing a user-selectable set (and/or root node) name field and/or a corresponding serially-numbered set identifier field, such that the set name field, which can contain the name of the hierarchically-organized and/or hierarchically-presentable set, can be referenced via its identifier field;
an “enrollment” (and/or “enrollee”) table containing one or more enrollment (and/or enrollee) records, each containing a serially-numbered enrollment identifier field, a member identifier field, and/or a corresponding set identifier field, such that each enrollment record can link a single member record with a single set record, these enrollment records collectively allowing each member to belong to any number of sets and/or each set to comprise any number of members;
within the enrollment table, a hierarchy indicator field that can designate for a given enrollment record and/or member record, the hierarchical layer and/or level that member occupies in a given set and/or its rank within that level (e.g., if a hierarchy indicator is 7.4.2, then that member can be considered to occupy rank 2 in hierarchical level 3, rank 4 in hierarchical level 2, and rank 7 in hierarchical level 1)(note that within the hierarchy indicator, although periods are used throughout this document, nearly any appropriate, authorized, unrestricted, unambiguous, predefined, programmer-selectable, and/or customizable symbol and/or combination of symbol can be used for the separators and/or delimiters between levels, such as short dash (−), long dash (−), equal (=), plus (+), asterisk (*), forward slash (/), back slash (\), pipe (|), exclamation point (!), period (.), comma (,), semi-colon (;), colon (:), caret (̂), and/or tilde (˜), etc.);
a “group” table containing one or more group records, each containing a group identifier and/or a user identifier, these group records collectively allowing each user to belong to any number of groups and/or each group to comprise any number of users;
a “privileges” table containing one or more set privileges records, each comprising a set identifier field, a group identifier field, and/or a privilege field (comprising values such as, e.g., view, edit, delete), such that each record can define a specific privilege for a given group for an identified set, these set privilege records collectively allowing each set to have differing security privileges for different groups;
a “member privileges” table containing one or more member privileges records, each containing a member identifier field, a group identifier field, and/or a privilege field (containing values such as, e.g., view, edit, delete), such that each record can define a specific privilege for a given group for an identified member, these member privilege records collectively allowing each member to have differing security privileges for different groups, and/or allowing a given member to have different privileges for a given group than other members of the same set;
at least one script or the like that can automatically display member records in a hierarchical view, such as an outline view and/or column view, etc.;
at least one script or the like that can automatically evaluate, and possibly replace, the values of one or more hierarchy indicator fields for any and/or every viewing user in response to, within a hierarchy and/or set of any user and/or viewing user:
   creation of a new member record;
   deletion of an existing member record; and/or
   movement of an existing member record;
at least one script or the like that can automatically re-sort the member records (and thus the values of the hierarchically-organized field) of a hierarchy and/or set for any and/or every user and/or viewing user when needed according to, for example, the values in the hierarchy indicator fields so that the values of the member field (and the presented records) are displayed according to the user-selected hierarchy and/or set;
at least one script or the like that can automatically store and/or restore, for each user who views a given hierarchical view, an expanded/collapsed status of each member of that view;
at least one script or the like that can automatically render, for any user, any hierarchical view according to its stored expanded/collapsed status for any of its members, such that one or more members of that view that are predetermined, pre-selected, and/or specified by any and/or each user are presented in an expanded (or collapsed) mode;
at least one script or the like that can automatically display member records in a non-hierarchical view, such as a list view, form view, and/or table view;
at least one script or the like that can automatically copy a member record and its descendants into the same original set, or into a new set that can be associated with the same and/or different layouts and/or accompanying fields than the original set, those copied member records specified to either continuing to mirror the data and/or values of their original member records (thereby performing as non-distinguishable clones of those originals) or to be permitted to deviate therefrom (thereby performing as potentially distinguishable derivatives of those originals) (note that each mirrored record (i.e., any member of a group comprising the original record and all its clones) can be visually indicated (such as via a predetermined symbol) so that any user encountering that record can recognize that any change (e.g., edit and/or deletion) of any value of that mirrored record in a given set will identically change the corresponding value of the corresponding records (each member of the group), whether those corresponding records appear in the same or in other sets);
at least one script or the like that can automatically sort and/or filter member records of a hierarchy and/or set without changing the values in their hierarchy indicator field, so the hierarchy of that set can be restored after sorting and/or filtering; and/or
at least one script or the like that can automatically create a new set from filtered member records and/or search results.

### Member Movement

Certain exemplary embodiments of the hierarchy processor can automatically provide any combination of various member “movement” functions, perhaps upon receipt of one or more menu selections and/or keyboard commands. For example, to move a member to the right within its hierarchy, that is, to change a member such that it becomes a child of its former sibling, the hierarchy processor automatically can require that member to have a sibling positioned directly above it, and/or change that member's hierarchy identifier to reflect that sibling's hierarchy identifier, concatenated with an additional level indicator that has a value reflecting the new position of the member under its former sibling. Thus, if the sibling (identified as 7.4) previously had 2 children identified as 7.4.1 and 7.4.2, and the member (formerly identified as 7.5) is moved to the right such that it becomes positioned as the third child of its former sibling, the hierarchical identifier of that moved member could be changed from 7.5 to 7.4.3. Alternatively, the moved member could be automatically positioned and identified as the first child under its new parent (e.g., 7.4.1), with the remaining children of that parent re-identified accordingly.

As another example, to move a member up within the hierarchy, that is, to change a member such that it becomes a higher positioned sibling under its parent, the hierarchy processor automatically can require that member to have a sibling positioned directly above it, change that member's hierarchy identifier to assume that sibling's hierarchy identifier, and/or change the sibling's identifier to reflect the member's former identifier. Thus, if a member labeled 7.5 is moved upwards by one rank, its identifier can change to 7.4, and its sibling formerly identified as 7.4 can now be identified as 7.5. This process can be repeated until the member has no siblings positioned above it and/or attains an identifier of 7.1. At that point, if possible, the member could be moved left to attain a higher position in the hierarchy.

To move a member downward in the hierarchy, that is, to change a member such that it becomes a lower positioned sibling under its parent, the hierarchy processor automatically can require that member to have a sibling positioned directly below it, change that member's hierarchy identifier to assume that sibling's hierarchy identifier, and/or change the sibling's identifier to reflect the member's former identifier. Thus, if a member identified 7.5 is moved downwards by one rank, its identifier can change to 7.6, and its sibling formerly identified as 7.6 can now be as automatically identified 7.5. This process can be repeated until the member has no siblings positioned below it. At that point, if possible, the member could be moved right to attain a still lower position in the hierarchy.

To move a member leftward in the hierarchy, that is, to change a member such that it becomes a sibling to its former parent, the hierarchy processor automatically can require that the member to have a parent, cause that member to assume its parent's identifier, incremented by one, and/or cause all siblings of the parent formerly positioned below the parent to have their identifiers incremented by one to accommodate their new sibling (former “niece”). This process can be repeated until the member is at the top layer and/or has no parent positioned above it.

### Member Labels

As described above, when the hierarchy processor moves a member within a hierarchy and/or hierarchical view, and that member's hierarchy identifier is automatically changed accordingly, the hierarchy processor automatically can move its descendants with it, and/or automatically change their hierarchy identifiers accordingly. Likewise, when a member is moved, its rendered and/or user-visible label can be automatically changed accordingly, as can the labels of its descendants that move with it. Thus, if a member labeled B.2 and having a child labeled B.2.a is moved leftward to become a sibling of its former parent, that moved member can be automatically relabeled as C and its child as C.1. Alternatively, if there were previously siblings having the labels of C and D, the moved member can be automatically relabeled as E (and its child E.1) and/or automatically positioned accordingly within the view.

Although the hierarchy processor can utilize an expanded numeric hierarchy identifier scheme and/or labeling scheme to track and/or present the layer and/or rank of each member of the set, different labeling schemes can be displayed to the user. For example, a user can elect to view labels according to any desired labeling scheme, such as for example, an alphabetical scheme (e.g., A, B, C, etc., and/or a, b, c, etc.), a Roman scheme (e.g., I, II, III, IV, V, etc., or i, ii, iii, iv, v, etc.), a Harvard scheme (e.g., 1-A-I-1-a-i-etc.), a collapsed numeric scheme (each member displays only its numeric rank value with respect to its siblings, and not its full layer and rank information), bullets and/or symbols (e.g., [symbol] , [symbol] , [symbol] , [symbol] , [symbol] , [symbol] , [symbol] , [symbol] , [symbol] etc.), and/or no scheme, etc. Likewise, any user-selectable intra-label separator scheme(s) (e.g., period, comma, semi-colon, colon, dash, slash, backslash, pipe, parenthesis, and/or bracket, etc.) can be displayed (e.g., “1-5-3-4”, “III:B/5.1”, etc.)

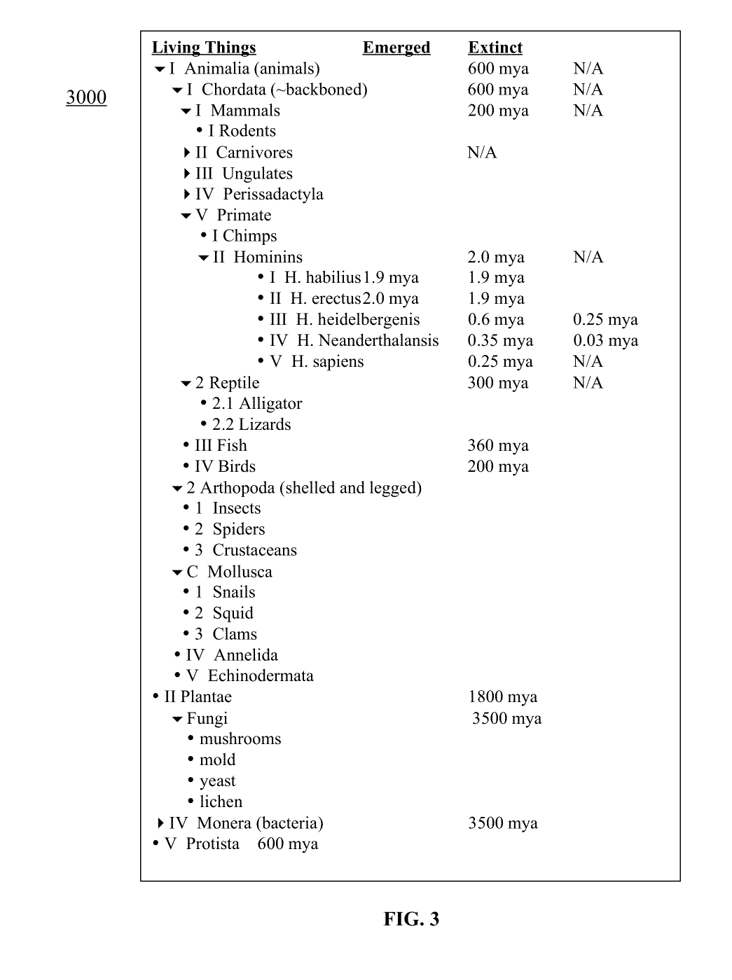

For example, in FIG. 3, the expanded numeric (“legal”) labeling scheme has been replaced predominately by a Roman labeling scheme, with some notable exceptions. For example, Reptile retains a legal labeling scheme, as do its children. As another example, Arthropoda has a collapsed numeric labeling scheme, as do its children. As yet another example, Mollusca as an alphabetical labeling scheme, but its children have collapsed numeric labels. As still another example, Fungi, and its children, have no labels displayed. Yet all of the members can retain their hidden expanded numeric hierarchical identifiers, which the hierarchy processor can utilize to keep track of and/or manipulate the layer and/or rank of each of those members.

### Member Expanding and Collapsing

The hierarchy processor can use any number of techniques to automatically expand and/or collapse a hierarchical view, such that only user-selected portions of the hierarchical view are visible to the user at a given time. One technique is the use of a visibility field and/or flag for each member record and/or each enrollment record. For example, to collapse a member such that none of its descendants are visible, the hierarchy processor, perhaps upon receipt of a menu selection and/or keyboard command, automatically can perform a find for all of those descendants, verify and/or change their visibility field to a value of Off, and/or then perform a find for all members having visibility fields with a value of On. Likewise, to expand a member such that all of its descendants are visible, the hierarchy processor automatically can perform a find for all of those descendants, verify and/or change their visibility field to a value of On, and/or then perform a find for all members having visibility fields with a value of On.

Data and/or Values

Referring to FIG. 3, certain exemplary embodiments can present and/or cause the presentation of at least one hierarchical view, which in this figure is shown as an outline view, although nearly all of the discussion herein regarding an outline view can apply equally to any other type of hierarchical view and/or semi-hierarchical view, such as a view of at least one nested column, tree, circular graph, folder structure, entity-relationship diagram, network diagram, calendar, time line, Gantt chart, Pert chart, critical path diagram, flow chart, block diagram, cause-effect diagram, organizational chart, Work Breakdown Structure Chart, TQM diagram, Venn diagram, UML diagram, etc., and/or any hierarchical view creatable using mind-mapping, graphing, visualization, and/or diagramming software, such as: the open source application GraphViz, available from the web site graphviz.org; the open source application FreeMind, available from the web site sourceforge.net; ConceptDraw Pro and/or related products, available from CS Odessa LLC of San Jose, Calif.; and/or yFiles and/or related products available from yWorks GmbH of Tubingen, Germany.

As an example of how a hierarchy, such as an outline, can be used to create a semi-hierarchical view, such as a flowchart, within the hierarchy of the outline, branches can be expressed as children of a parent (such as a decision block), and/or loops and/or pointers can be expressed as one or more hyperlinks of a member. The flowchart (and/or other graphical views) can comprise automatically determined and/or user-specifiable graphical elements, each surrounding the corresponding text from a member of the hierarchy. Attributes of all, any, and/or each graphical element, such as shape, size, scaling, position, rotation, shading, 3-D effects, arrangement, alignment, distribution, border thickness, border pattern, border colors, border transparency, border style, fill colors, fill transparency, fill effect, fill shading, fill texture, fill pattern, fill picture, text font, text size, text style, text color, text transparency, and/or text position, text anchor point, text margins, text wrapping, element resizing to fit text, text rotation, etc., can be automatically determined and/or specified via one or more secondary fields of the hierarchy. Attributes of any connectors between graphical elements of the flowchart, such as directionality, thickness, dashing, style (straight, curved, elbowed, etc.), pattern, color, transparency, origin (e.g., arrowhead) type (if any), origin size, termination (e.g., arrowhead) type (if any), and/or termination size, etc., can be automatically determined and/or specified via one or more secondary fields of the hierarchy. Any such attributes can be “inherited” by members from one or more of their ancestor members.

The outline view of FIG. 3 presents a user-selectable group of records (“set”) having a user-selectable hierarchically-organized and/or hierarchically-presentable member field, such as the Living Things field, and any number of user-selectable subsidiary, secondary, and/or accompanying non-hierarchically-organized fields, such as the Emerged field and the Extinct field (where “mya” means million years ago).

In certain exemplary embodiments, the values and/or data of any field can be automatically processed and/or presented in any manner possible by the database management system. For example, as desired, data can be formatted, validated, serve as input to a calculation, and/or summarized.

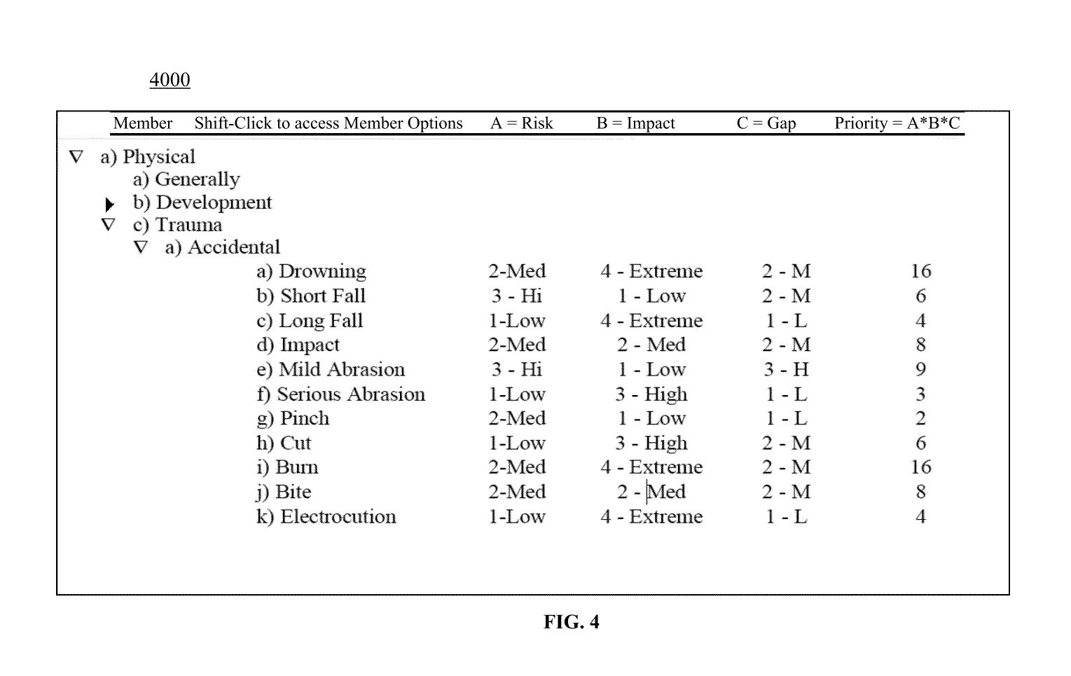

FIG. 4 presents an exemplary outline view showing a hierarchically organized member field and several fields (labeled “A=Risk”, “B=Impact”, “C=Gap”, and “Priority=A*B*C”) that are subsidiary and/or related to that member field and/or are organized to present data in columns. Fields A, B, and C serve as inputs to the calculated Priority field, the values for which are determined by trimming the numeric portions of fields A, B, and C, and multiplying the results.

In certain exemplary embodiments, the formatting of any displayed field can be user-selectable and/or programmable. For example, a user can select the number of digits to be displayed to the right of a decimal point in a calculated numerical field. As another example, a user can select that a data field is to be displayed in DD-MMM-YYYY format. As another example, a user can select that a text field called “Note” is to be presented in bold red Arial 16 point text, surrounded by a 2 point navy blue line, and/or shaded in very light yellow, when an “Overdue Amount” field has positive value.

Potential values for any field can be specified via a value list and/or presented via at least one checkbox, radio button, pop-up menu, drop-down list. Previously entered data of a field can be provided in a “type it for me” or “type ahead” manner to any other field, thereby providing an auto-complete field.

### Set Access

In certain exemplary embodiments, the hierarchy processor automatically can take advantage of the multi-user aspects of the database management system to allow multiple users to simultaneously access, edit, and/or manipulate (e.g., move, change formatting, and/or clone one or more members of, etc.) a given set. Depending on the data integrity features of the database management system, certain exemplary embodiments can allow multiple users to edit a given set, avoiding conflicts via, for example, record-level locking field-level locking, and/or byte-level locking Certain exemplary embodiments can utilize permissions and/or privileges to allow a designated “owner” of a given set to specify what individuals and/or groups are permitted to access, edit, delete, print, etc., the records of that set and/or any particular record of that set.

Certain exemplary embodiments can provide a user with an ability to add, modify, and/or delete a record in one or more user-selectable sets. Thus, a user can, for example, specify the set or sets to be impacted by such an addition, modification, or deletion of a record.

### Alternative Views

Certain exemplary embodiments can provide a user with an ability to view records, from one or more of user-selectable tables of one or more user-selectable databases, in any user-selectable view, such as a hierarchical outline view, hierarchical column view, list view, free-form view, and/or tabular view, etc.

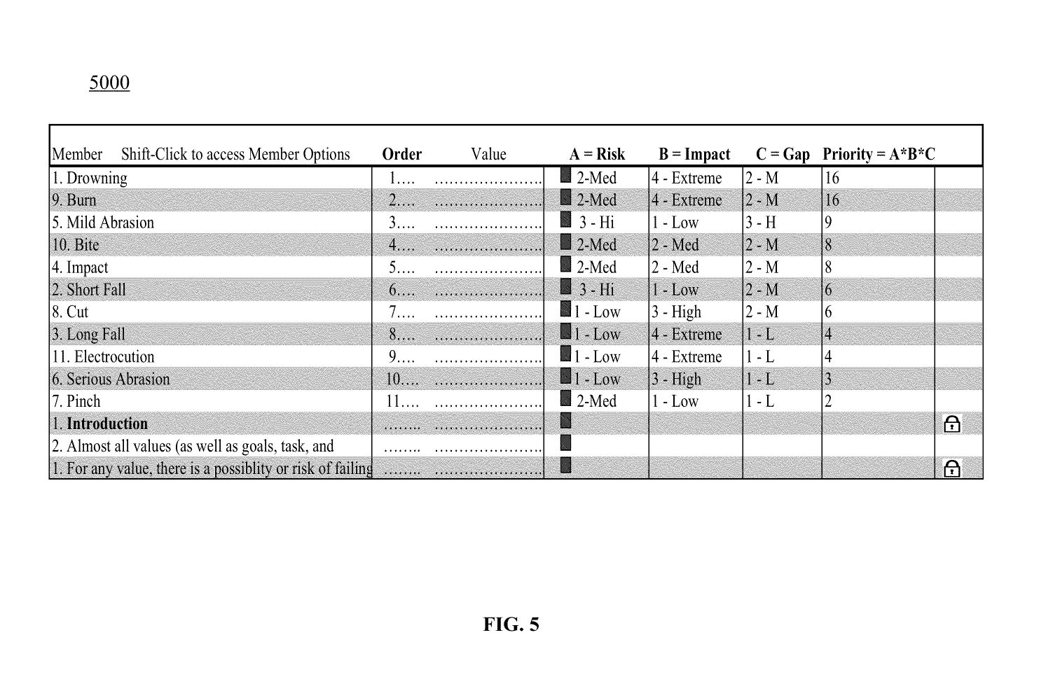

For example, FIG. 5 presents a non-hierarchical list view of certain records presented hierarchically in FIG. 4. Note that in FIG. 5, these records have been automatically sorted by Order without the hierarchy processor loosing track of their positions (layer and rank) in the hierarchy. That is, the user can freely switch between and/or simultaneously display this list view and a hierarchical view, with each view maintaining its appropriate ordering (i.e., sorted by Order vs. hierarchical) of these records. Note also that FIG. 5 shows a lock indicator next to 2 records near the bottom. This indicator can mean that these records have different security permissions and/or privileges than those of the remaining records in this set.

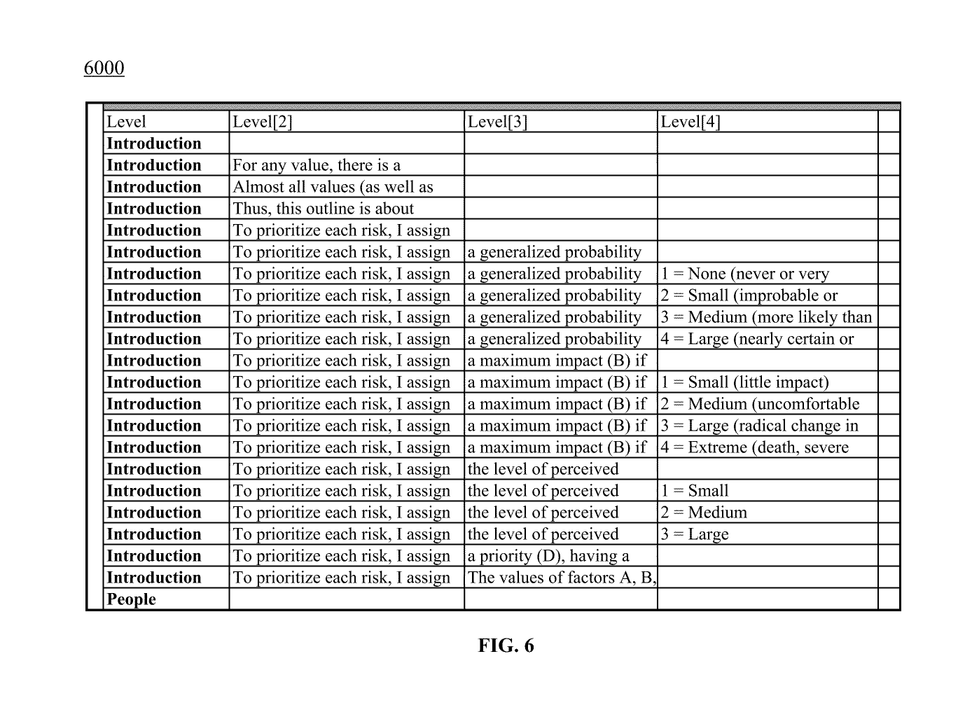

As another example, FIG. 6 presents a non-hierarchical table view of certain records presented hierarchically in the outline of FIG. 4.

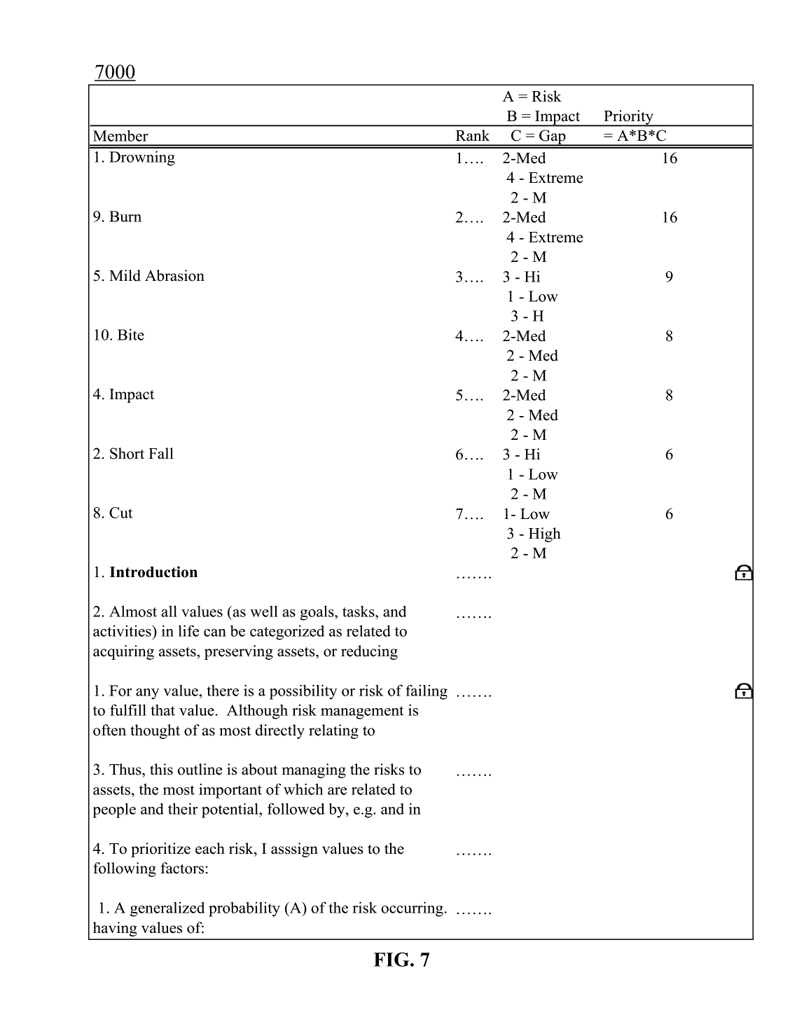

As yet another example, FIG. 7 presents a non-hierarchical form view of certain records presented hierarchically in the outline of FIG. 4.

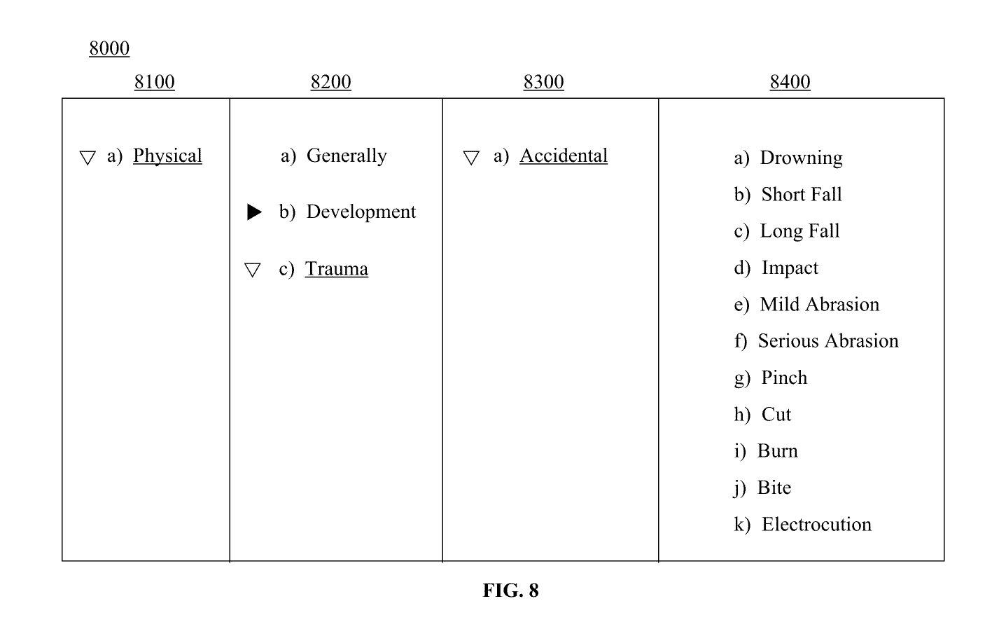

As still another example, FIG. 8 presents a hierarchically-presented or nested column view of certain records that are presented hierarchically in the outline of FIG. 4. The selected element from each column 8100, 8200, 8300, 8400 can be identified, such as via text formatting, highlighting, symboling, etc. Automatically and/or upon user input, elements can be expanded or collapsed to show or hide their descendants. One or more indicators, such as formatting, highlighting, symbols, etc., automatically can be generated and/or displayed to indicate whether a given element has children and/or whether those children are displayed or hidden. For example, in FIG. 8, in column 8200, the element “a) Generally” is accompanied by no symbol, which can indicate that it has no children. In that same column 8200, the element “b) Development” is accompanied by a rightward pointing “solid” triangle, which can indicate that it has children but has not been expanded to display them. In that same column 8200, the element “c) Trauma” is accompanied by a downward pointing “empty” triangle, which can indicate that it has children and has been expanded to display them.

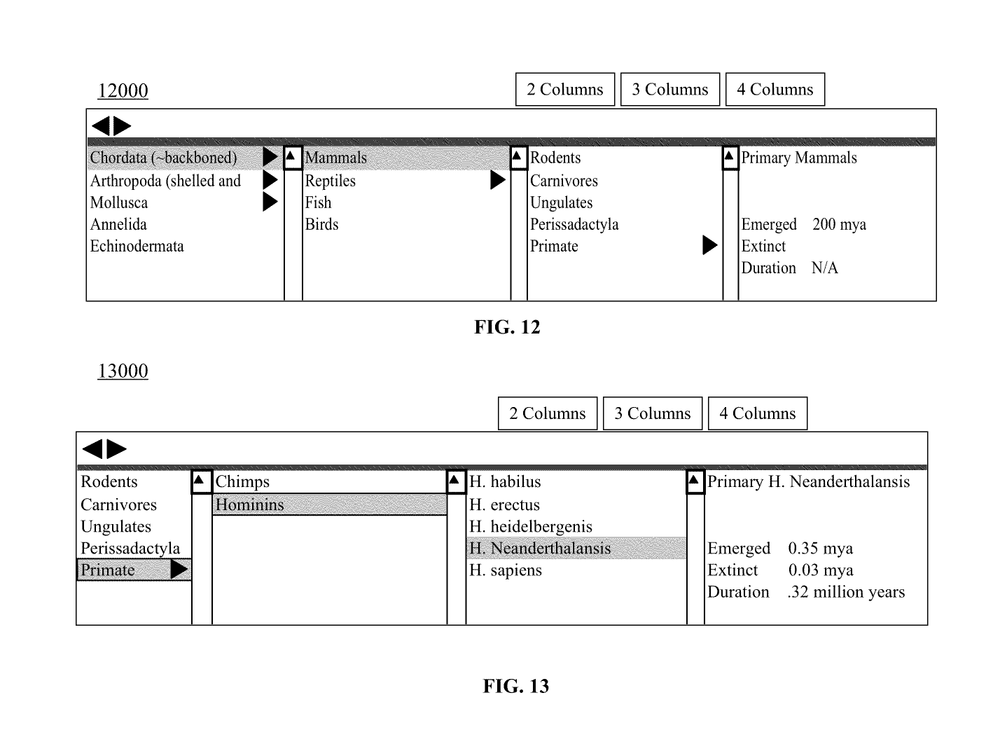

As still another example, FIGS. 12 and 13 present a hierarchically-presented or nested column view of certain records that are presented hierarchically in the outline of FIG. 3. Referring to FIG. 12, note that when a member (such as “Primates”) having descendants is selected, the columns automatically “slide” to the left to expose its direct descendants (such as “Hominins”) When one of those direct descendants (such as “Hominins”) is selected, the columns again slide to the left, so that its direct descendants (such as “H. Neanderthalansis” and “H. sapiens”) are displayed, which is shown in FIG. 13. Conversely, referring to FIG. 13, if a member of a left hand column is selected (such as “Primates”), then the columns automatically slide to the right to reveal one or more generations of its ancestors (such as “Mammals”), and any siblings of those ancestors (such as “Reptiles”). Additional selections from the left-most column will eventually “walk-up” the hierarchy to the top-most member. Note also that the value shown in the Duration field reflects the value in the Emerged field minus the value in the Extinct field, and thus a cross-column calculation.

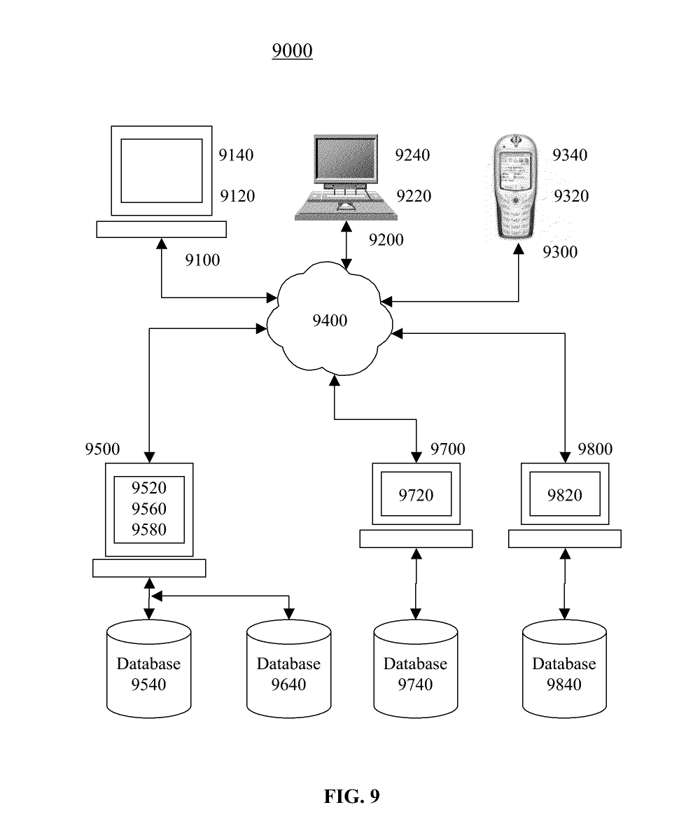

FIG. 9 is a block diagram of an exemplary embodiment of a system 9000, which can comprise any number of user information devices, such as a desktop computer 9100, laptop computer 9200, smartphone and/or PDA 9300, etc. Any of user information devices 9100, 9200, 9300 can comprise a database management system client 9120, 9220, 9320 and/or an hierarchy processor 9140, 9240, 9340. Any of user information devices 9100, 9200, 9300 can be communicatively coupled via a network 9400 to a server 9500, which can comprise a database management system server 9520, an hierarchy processor 9560, a user and/or administrator interface 9580. Server 9500 can be communicatively coupled to one or more databases 9540, 9640. Likewise, server 9600 can be communicatively coupled to one or more servers 9700, 9800, any of which can comprise a database management system and/or file management system 9720, 9820, respectively, and/or can be communicatively coupled to one or more databases 9740, 9840.

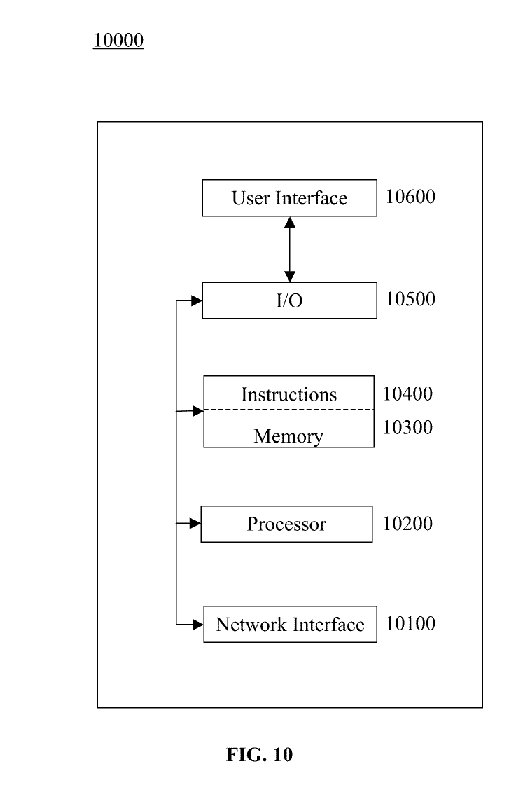

FIG. 10 is a block diagram of an exemplary embodiment of an information device 10000, which in certain operative embodiments can comprise, for example, user information device 9100, 9200, and/or 9300, and/or server 9500, 9700, and/or 9800 of FIG. 9. Information device 10000 can comprise any of numerous circuits and/or components, such as for example, one or more network interfaces 10100, one or more processors 10200, one or more memories 10300 containing instructions 10400, one or more input/output (I/O) devices 10500, and/or one or more user interfaces 10600 coupled to I/O device 10500, etc.

In certain exemplary embodiments, via one or more user interfaces 10600, such as a graphical user interface, an information device can implement a hierarchy processor and/or any activity described herein, such as providing a rendering of information to a user, such as via a hierarchical and/or non-hierarchical view as described herein.

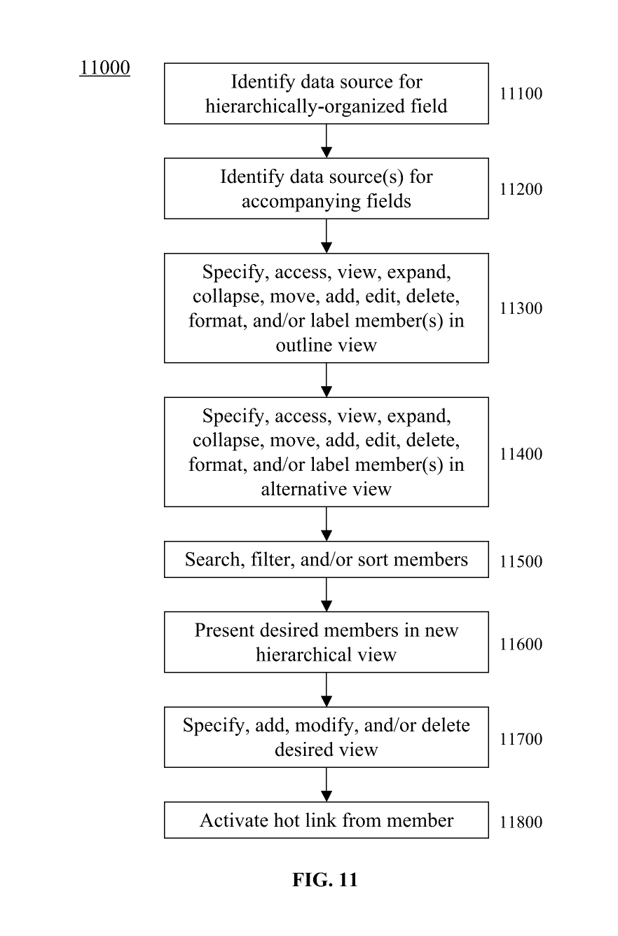

FIG. 11 is a flowchart of an exemplary embodiment of a method 11000. At activity 11100, a data source for one or more hierarchically-organizable and/or hierarchically-presentable fields of a set can be identified. At activity 11200, one or more data sources for one or more additional fields of the hierarchical view can be identified. At activity 11300, one or more members of the set, hierarchy, and/or hierarchical view can be specified, accessed, rendered, viewed, expanded, collapsed, moved, added, edited, deleted, formatted, and/or labeled within the hierarchical view in a user-programmable, networkable, server-deployable, web-accessible, browser-compatible, SQL table-connectable, ODBC-compatible, securable, multi-user, cross-platform, object-oriented, and/or relational manner. At activity 11400, one or more members of the hierarchical view can be rendered, viewed, expanded, collapsed, moved, added, edited, deleted, formatted, and/or labeled in an alternative hierarchical and/or non-hierarchical view in a similar or different manner. At activity 11500, members of the set, hierarchy, and/or hierarchical view can be searched, filtered, and/or sorted in a non-hierarchical view. At activity 11600, one or more user-specified members of a set, hierarchy, hierarchical view, and/or a non-hierarchical view can be presented in a new hierarchical view. At activity 11700, a user-specified hierarchical view and/or a non-hierarchical view can be specified, added, modified, and/or deleted. At activity 11800, for a selected member, a hot link can be activated to navigate to, access, run, and/or open any desired database view, web page, and/or electronic file, document, and/or program.

### External Data Sources

Certain exemplary embodiments can allow, via a hierarchy processor, user-directed and/or automatic: access, presentation, display, rendering, organization, creation, modification, and/or deletion of one or more data and/or records from an external data source, which can be can any data source and/or structure other then the hierarchy processor (which can serve as an internal data source to itself), such as any structured, semi-structured, partially structured, irregularly structured, implicitly structured, and/or potentially even any searchable: electronic object, heap, set, graph, table, array, record, list, tree, document, file, web page, archive, store, databank, and/or database, etc., which can include an HTML, XML, and/or Excel file, and/or an SQL, SQLite, Access, and/or FileMaker, etc. file and/or database, etc. In certain exemplary embodiments, the external data source can provide control information, for example in the form of tags for attributes such as level, rank, paragraghs, images, checkboxes, flags, hyperlinks, graphical element attributes, and/or custom controls, that can specify how the hierarchy processor is to position and/or format the external data.

For the hierarchy processor to utilize external data, certain exemplary embodiments can allow a user to generally, parametrically, and/or particularly specify, for each external data and/or data element:
an identity and/or address of its external data source (e.g., database, document, file, tables, records, and/or fields, etc.);
an identity of the set to which the external data will be provided;
how the external data will be filtered (if at all);
how the external data will be automatically positioned within a hierarchy of the set;
how the external data will be formatted;
how changes (e.g., additions, modifications, and/or deletions, etc.) of any portion of the external data that occur other than by the hierarchy processor will be dynamically detected and/or rendered by the hierarchy processor;
how external changes that occur to the external data will be flagged for review;
how the hierarchy processor is permitted to change (e.g., add, modify, and/or delete, etc.) any portion of the external data;
how internal changes to the external data will be flagged for review within the hierarchy,
how changes made by the hierarchy processor on any portion of the external data will be dynamically detected and/or rendered by the external data source;
how changes made by the hierarchy processor on any portion of the external data will be flagged for review in the external data source; and/or
how headers for the external data will be created within the hierarchy and/or set, etc.;
etc.

In certain exemplary embodiments, if the external data is to be automatically positioned with the hierarchy of a set, the user can specify how the data maps to the levels of the hierarchy. For instance, a single field of the external data can be mapped to multiple levels, e.g., a first letter of a Last Name field in an address book external data source can be mapped to level 1, and the entire data of the Last Name field (potentially concatenated with the data of First Name field to promote unique and/or more unique hierarchical records) can be mapped to level 2. Extending this example, multiple fields can be mapped onto multiple levels, e.g., in addition to the preceding example, data (and/or label therefore) of one or more telephone number fields (e.g., home, work, mobile, fax, etc.) can be mapped to level 3. A provision can be made for specifying how each level is to be ranked and/or ordered, such as, for example, ascending, descending, custom, etc. Thus, a partial hierarchy for such data might resemble the following:
D
   Duck, Daisy
      Home: 908-555-1212
      Work: 908-888-9999
      Cell: 517-272-9999
   Duck, Donald
      Home: 908-555-1212
      Work: 908-999-1212
      Cell: 202-555-9999

In this example, the level 2 data can be considered to be an ascendingly-ranked, calculated, comma-separated concatenation of the Last Name field and the First Name field. The level 3 data, which might represent multiple occurrences of a phone number field and a phone number type field, or possibly multiple types of phone number fields, appears to be ranked in a user-specified custom order (i.e., Home, Work, Cell).

In addition to specifying the hierarchically-organized (“primary”) data, the user can also specify the secondary data and/or fields from each external data source (and/or entered directly in the hierarchy processor) that will accompany the primary data. For example, in the above example, columnarly-rendered non-hierarchical data describing best days and/or times for reaching the person via each phone number can accompany each phone number.

### External Data Targets

Certain exemplary embodiments can allow, via a hierarchy processor, user-directed and/or automatic access, presentation, display, rendering, organization, creation, modification, and/or deletion of one or more data and/or records to an external data target, which can be can any data target and/or structure other than the hierarchy processor (which can serve as an internal data source to itself), such as any structured, semi-structured, partially structured, irregularly structured, implicitly structured, and/or potentially even any searchable: electronic object, heap, set, graph, table, array, record, list, tree, document, file, web page, applet, plug-in, script, program, application, archive, store, databank, and/or database, etc., which can include any mind-mapping, graphing, visualization, and/or diagramming software, an HTML, XML, and/or Excel file, and/or an SQL, SQLite, Access, and/or FileMaker, etc. file and/or database, etc. In certain exemplary embodiments, the external data target can receive control information, for example in the form of tags for attributes such as level, rank, paragraghs, images, checkboxes, flags, hyperlinks, graphical element attributes, and/or custom controls, that can specify how the external data target is to position and/or format the received data.

Likewise, the data of all and/or selected fields, members, and/or records of any set can be exported in any desired format, and/or transferred, such as via a system clipboard, for use in any external data target.

### Potential Application—Social Networks

As a potential application of an exemplary hierarchy processor, in a social network context, the hierarchy processor might obtain the names of individuals from one or more external data sources containing data relating to a user, such as the user's electronic address book, calendar, phone log, postal log, encounter log, chat messages, blog entries and/or file, and/or e-mail messages, etc. Such data might be mapped by the hierarchy processor to create numerous records, each of those records corresponding to an individual who is associated with the user. Those records can be grouped under one or more social network records that can be created, named, and or presented, manually and/or automatically, to correspond to one or more actual, determined, and/or inferred social networks of the user, each network having as its children those records representing corresponding associated individuals. For example, a given user might have member records for various social networks of that user, such as Family, Professional Colleagues, Personal Friends, Soccer Teammates, Neighbors, Rock & Gem Club, etc., each of which can have their own children records representing associated individuals who fit those categories for the user. Thus, the hierarchy processor might determine that Mark has a Friend named Sue. Within the hierarchy, the hierarchy processor might recognize that a broader social network can have one or more narrower sub-social networks thereunder, and any of them can have a still narrower sub-social network thereunder, and so on.

In some cases, an associated individual can belong to 2 or more social networks of the user, in which case, as desired, the hierarchy processor and/or the user can create cloned and/or new social network records and/or associated individual records. The social network records and/or the associated individual records can be automatically sorted within the hierarchy. For example, associated individuals can be ranked by their “closeness” to the user, which can potentially be inferred and/or determined by frequency, method, time, etc., of communication.

In certain exemplary embodiments, each created social network can be “reverse analyzed” to determine sets, hierarchies, members, records, and/or social networks for each of the associated individuals. That is, if the hierarchy processor “knows” that Mark has a Friend named Sue, it reasonably might infer that Sue has a Friend named Mark. In some cases, names for social networks and/or associated individuals within such social networks can be automatically determined and/or inferred based on attributes held in common by individuals. For example, 2 individuals having the same surname and address might be reasonably inferred as belonging to each other's Family social network. Similarly, 2 individuals having the same employer, work address, and/or e-mail domain might be reasonably inferred as belonging to each other's Employer and/or Professional social network.

The data of all and/or selected fields, members, and/or records of any social network hierarchy, set and/or subset can be output, as desired, to an external data target, such as diagramming software that graphically illustrates the social network for each output member.

### Potential Application—Unified Communications Log

As another potential application of an exemplary hierarchy processor, in a unified communication log context, the hierarchy processor might obtain data such as communications and/or meta-data related thereto from any number of external data sources for any number of types of communications such as the user's cell phone calls, landline calls, voice-mail messages, pages, faxes, postal mail, e-mail messages, instant (chat) messages, blog entries, tweets, diary entries, in-person conversations, etc.

Such data might be mapped by the hierarchy processor to records of one or more sets, each of those records corresponding to a communication associated with the user. Those records can be grouped under one or more headers, such as headers for communication date/time, type, subject, and/or communication partners, etc., that can be created, named, and or presented, manually and/or automatically, to correspond to one or more actual, determined, and/or inferred attributes of the communications, each header having as its children those records representing corresponding associated communications. For example, a given hierarchy and/or might have header records for the above-listed types of communications. Alternatively and/or in addition, a hierarchy might have header records for others (communication partners) involved in communications with the user, subsidiary headers for general subject matter, and/or communication records ranked by date/time, with secondary fields for urgency, communication type, tags, etc.

Such records can utilize address book and/or calendar data to provide hot-links to relevant related data, such as a telephone number, fax number, chat address, e-mail address, postal address, meeting, task, project, etc., for and/or involving a given communication partner, to generate a new communication to that partner, to schedule a meeting with that partner, etc.

Thus, certain exemplary embodiments can provide a system, machine, device, manufacture, circuit, and/or user interface adapted for, and/or a method and/or machine-readable medium comprising machine-implementable instructions for, activities that can comprise: via a hierarchy processor implemented via a predetermined information device: for each of a plurality of records of a data structure, displaying data corresponding to a hierarchically displayable field according to a hierarchy location field containing a corresponding hierarchy location identifier indicative of a display location of that data in a displayable hierarchical data structure.

Certain certain exemplary embodiments can provide a system, machine, device, manufacture, circuit, and/or user interface adapted for, and/or a method and/or machine-readable medium comprising machine-implementable instructions for, activities that can comprise: via a hierarchy processor implemented via a predetermined information device:
accessing a data source, said data source comprising a first data structure comprising a plurality of records comprising data organized by a plurality of fields;
determining a second data structure based on an automatic analysis of each record of the plurality of records, said second data structure defining a hierarchy location field containing, for each record, a corresponding hierarchy location identifier indicative of a display location of data corresponding to a hierarchically displayable field of that record in a displayable hierarchical data structure;
displaying data corresponding to said hierarchically displayable field of said plurality of records according to said displayable hierarchical data structure;
synchronizing changes to data corresponding to said hierarchically displayable field of any of said plurality of records between said first data structure and said second data structure;
responsive to user input, automatically changing the hierarchy location identifier for each of a first subplurality of records from said plurality of records, and automatically modifying said displayable hierarchical data structure according to said changed hierarchy location identifiers;
causing data corresponding to said hierarchically displayable field of a first predetermined record to appear in multiple display locations in said displayable hierarchical data structure;
responsive to user input, automatically hiding descendants of a second predetermined record from displaying in said displayable hierarchical data structure;
based on user-provided criteria, preventing a third subplurality of said records from displaying in said displayable hierarchical data structure;
responsive to a user selection of the hierarchically displayable field of a predetermined record, activating a script; and/or
sorting said plurality of records without modifying said hierarchy location identifier associated with each of said records;
etc.

### Definitions

When the following terms are used substantively herein, the accompanying definitions apply. These terms and definitions are presented without prejudice, and, consistent with the application, the right to redefine these terms during the prosecution of this application or any application claiming priority hereto is reserved. For the purpose of interpreting a claim of any patent that claims priority hereto, each definition (or redefined term if an original definition was amended during the prosecution of that patent), functions as a clear and unambiguous disavowal of the subject matter outside of that definition.
a—at least one.
access—(v) to enter, approach, communicate with and/or through, make use of, and/or pass to and/or from.
activate—to actuate and/or set in motion and/or action.
activity—an action, act, deed, function, step, and/or process and/or a portion thereof.
adapted to—made suitable or fit for a specific use or situation.
analysis—the act, process, and/or result of analyzing; an evalution; and/or an evaluation of the constituents of
and/or—either in conjunction with or in alternative to.
apparatus—an appliance or device for a particular purpose
appear—to be visible and/or present.
associate—to join, connect together, accompany, and/or relate.
automatically acting or operating in a manner essentially independent of external influence or control. For example, an automatic light switch can turn on upon “seeing” a person in its view, without the person manually operating the light switch.
based—being derived from.
between—in a separating interval and/or intermediate to.
Boolean logic—a complete system for logical operations.
can—is capable of, in at least some embodiments.
cause—to bring about, provoke, precipitate, produce, elicit, be the reason for, result in, and/or effect.
change—(v.) to cause to be different; (n.) the act, process, and/or result of altering or modifying.
circuit—a physical system comprising: an electrically conductive pathway and/or a communications connection established across a switching device (such as logic gates); and/or an electrically conductive pathway and/or a communications connection established across two or more switching devices comprised by a network and between corresponding end systems connected to, but not comprised by the network.
circuit—an electrically conductive pathway and/or a communications connection established across two or more switching devices comprised by a network and between corresponding end systems connected to, but not comprised by the network.
comprising—including but not limited to.
configure—to make suitable or fit for a specific use or situation.
contain—to hold or keep within limits, restrain, and/or store.
convert—to transform, adapt, and/or change.
corresponding—related, assoicated, accompanying, similar in purpose and/or position, conforming in every respect, and/or equivalent and/or agreeing in amount, quantity, magnitude, quality, and/or degree.
create—to bring into being.
criterion—a standard, rule, or test on which a judgment or decision can be based; a basis for comparison; a reference point against which other things can be evaluated.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the meaning, relationship, outline, form, and/or structure of; and/or to precisely and/or distinctly describe and/or specify.
descendant an element that logically is contained by, and/or belongs to, another element, either directly or indirectly.
determine—to obtain, calculate, decide, deduce, and/or ascertain.
device—a machine, manufacture, and/or collection thereof
digital—non-analog and/or discrete.
display—(v.) to visually render. (n.) an electronic device that represents information in visual form and/or a visual representation of something.
each—every one of a group considered individually.
estimate—to calculate and/or determine approximately and/or tentatively.
field—a logical storage space for a type of data. A field can contain textual, numeric, date, graphical, audio, video, animated, and/or calculated data. A field can have properties comprising a fixed or variable length, a pre-defined display format, validation properties, and/or relatability to another field.
from—used to indicate a source.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
having—including but not limited to.
hide—to cloak and/or make not visible.
hierarchical—a logical structure that classifies, orders, arranges, ranks, displays, presents, and/or renders a given set of information according to various criteria into a series of steps and/or successive levels and/or layers, for example, starting with broad, simple classifications, and proceeding, in stages, toward more narrow, specific classifications.
hierarchy—a system of classifying, ordering, arranging, ranking, displaying, presenting, and/or rendering data and/or information, where each element of the system (except for the top element) is a direct subordinate (i.e., “child”) of a single other element (i.e., “parent”). A given child can have a serial lineage formed of many ancestor elements. A given parent can have multiple children (each of which can be siblings to one another), and therefore multiple descendants, such as grandchildren, great-grandchildren, etc.
human-machine interface—hardware and/or software adapted to render information to a user and/or receive information from the user; and/or a user interface.
identifier—a group of symbols that are unique to a particular entity, object, activity, service, relationship, characteristic, and/or document. An identifier can be, for example, a medical record number. An identifier can be human and/or machine readable and/or understandable, such as for example, a number, alphanumeric string, code, bar code, RFID, etc.
identify—to specify, recognize, detect, and/or establish the identity, origin, nature, and/or definitive characteristics of
identity—the collective aspect of the set of characteristics by which a thing is definitively recognizable and/or known, and/or information that distinguishes an entity.
including—including but not limited to.
indicative—serving to indicate.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as an iPhone and/or Treo-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input—a signal, data, and/or information provided to a processor, device, and/or system.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions, which can be implemented as firmware and/or software, the directions adapted to perform a particular operation or function.
location —a place.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. . Thus, each electronic logic gate typically requires power so that it can source and/or sink currents to achieve the correct output voltage. Typically, machine-implementable instructions are ultimately encoded into binary values of “0”s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine-implementable instructions. This is one of the basic concepts underlying digital computing. At the register and/or gate level, a computer does not treat these “0”s and “1”s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine-implementable instructions. For example, if the encoding request a calculation, the logic gates might add the first two bits of the encoding together, produce a result “1” (“0”+“1”=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
machine-implementable instructions—directions adapted to cause a machine, such as an information device, to perform one or more particular activities, operations, and/or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied and/or encoded as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can store and/or obtain machine-implementable instructions, data, and/or information. Examples include a memory device, punch cards, etc.
may—is allowed and/or permitted to, in at least some embodiments.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
method—one or more acts that are performed upon subject matter to be transformed to a different state or thing and/or are tied to a particular apparatus, said one or more acts not a fundamental principal and not pre-empting all uses of a fundamental principal.
modify—to change, cause to change, edit, alter, replace, delete, and/or correct.
multiple—more than one.
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, ethernet card, cable modem, digital subscriber line interface, bridge, hub, router, or other similar device, software to manage such a device, and/or software to provide a function of such a device.
organize—to order and/or arrange.
packet—a generic term for a bundle of data organized in a specific way for transmission, such as within and/or across a network, such as a digital packet-switching network, and comprising the data to be transmitted and certain control information, such as a destination address.
perceptible—capable of being perceived by the human senses.
physical—tangible, real, and/or actual.
physically—existing, happening, occurring, acting, and/or operating in a manner that is tangible, real, and/or actual.
plurality—the state of being plural and/or more than one.
predetermined—established in advance.
prevent—to impede, resist, hinder, stop, and/or keep from happening.
probability—a quantitative representation of a likelihood of an occurrence.
processor—a hardware, firmware, and/or software machine and/or virtual machine physically adaptable to perform, via boolean logic operating on a plurality of logic gates, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
project—to calculate, estimate, or predict.
provide—to furnish, supply, give, and/or make available.
receive—to get as a signal, take, acquire, and/or obtain.
recommend—to suggest, praise, commend, and/or endorse.
record—a collection of structured data elements organized by fields. A group of records forms a file, table, and/or database. For example, a record might comprise data elements stored in fields such as: a name field, an address field, and a phone number field.
render—to, e.g., physically, chemically, biologically, electronically, electrically, magnetically, optically, acoustically, fluidically, and/or mechanically, etc., transform information into a form perceptible to a human as, for example, data, commands, text, graphics, audio, video, animation, and/or hyperlinks, etc., such as via a visual, audio, and/or haptic, etc., means and/or depiction, such as via a display, monitor, electric paper, ocular implant, cochlear implant, speaker, vibrator, shaker, force-feedback device, stylus, joystick, steering wheel, glove, blower, heater, cooler, pin array, tactile touchscreen, etc.
repeatedly—again and again; repetitively.
request—to express a desire for and/or ask for.
responsive—reacting to an influence and/or impetus.
said—when used in a system or device claim, an article indicating a subsequent claim term that has been previously introduced.
script—a machine-implementable program, routine, set of instructions, etc.
select—to make a choice or selection from an assortment.
selection—the act of choosing and/or selecting and/or an assortment of things from which a choice can be made.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
signal—automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc., that encode information, such as machine-implementable instructions for activities and/or one or more letters, words, characters, symbols, signal flags, visual displays, and/or special sounds, etc., having prearranged meaning Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
simultaneously—at substantially the same time.
sort—to arrange in a defined order and/or sequence.
source—an original and/or intermediate transmitter of traffic and/or a related group of such transmitters and/or a point at which something originates, springs into being, and/or from which it derives and/or is obtained.
special purpose computer—a computer and/or information device comprising a processor device having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
special purpose processor—a processor device, having a plurality of logic gates, whereby at least a portion of those logic gates, via implementation of specific machine-implementable instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine-implementable instructions to the logic gate's specific configuration and property(ies). In the context of an electronic computer, each such change in the logic gates creates a specific electrical circuit, thereby directly tying the specific machine-implementable instructions to that specific electrical circuit.
store—to place, hold, and/or retain data, typically in a memory.
subplurality—a subset.
substantially—to a great extent or degree.
synchronize—to cause to match, at least in part.
system—a collection of mechanisms, devices, machines, articles of manufacture, processes, data, and/or instructions, the collection designed to perform one or more specific functions.
transform —to change in measurable: form, appearance, nature, and/or character.
transmit—to send as a signal, provide, furnish, and/or supply.
user—a person, organization, process, device, program, protocol, and/or system that uses a device, system, process, and/or service.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
user-provided—supplied by a user.
via—by way of and/or utilizing.
weight—a value indicative of importance.
without—not accompanied by.

### Note

Various substantially and specifically practical and useful exemplary embodiments of the claimed subject matter, are described herein, textually and/or graphically, including the best mode, if any, known to the inventors for carrying out the claimed subject matter. Variations (e.g., modifications and/or enhancements) of one or more embodiments described herein might become apparent to those of ordinary skill in the art upon reading this application. The inventors expect skilled artisans to employ such variations as appropriate, and the inventors intend for the claimed subject matter to be practiced other than as specifically described herein. Accordingly, as permitted by law, the claimed subject matter includes and covers all equivalents of the claimed subject matter and all improvements to the claimed subject matter. Moreover, every combination of the above described elements, activities, and all possible variations thereof are encompassed by the claimed subject matter unless otherwise clearly indicated herein, clearly and specifically disclaimed, or otherwise clearly contradicted by context.

The use of any and all examples, or exemplary language (e.g., “such as”) provided herein, is intended merely to better illuminate one or more embodiments and does not pose a limitation on the scope of any claimed subject matter unless otherwise stated. No language in the specification should be construed as indicating any non-claimed subject matter as essential to the practice of the claimed subject matter.

Thus, regardless of the content of any portion (e.g., title, field, background, summary, description, abstract, drawing figure, etc.) of this application, unless clearly specified to the contrary, such as via explicit definition, assertion, or argument, or clearly contradicted by context, with respect to any claim, whether of this application and/or any claim of any application claiming priority hereto, and whether originally presented or otherwise:
there is no requirement for the inclusion of any particular described or illustrated characteristic, function, activity, or element, any particular sequence of activities, or any particular interrelationship of elements;
no characteristic, function, activity, or element is “essential”;
any elements can be integrated, segregated, and/or duplicated;
any activity can be repeated, any activity can be performed by multiple entities, and/or any activity can be performed in multiple jurisdictions; and
any activity or element can be specifically excluded, the sequence of activities can vary, and/or the interrelationship of elements can vary.

The use of the terms “a”, “an”, “said”, “the”, and/or similar referents in the context of describing various embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted.

Moreover, when any number or range is described herein, unless clearly stated otherwise, that number or range is approximate. Recitation of ranges of values herein are merely intended to serve as a shorthand method of referring individually to each separate value falling within the range, unless otherwise indicated herein, and each separate value and each separate subrange defined by such separate values is incorporated into the specification as if it were individually recited herein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

1. A method comprising:
via a hierarchy processor implemented via a predetermined information device:
accessing a first data source simultaneously accessible by each of a first plurality of users, said first data source comprising a first data structure comprising a plurality of records comprising data organized by a plurality of fields;
determining a second data structure based on an automatic analysis of each record of the plurality of records, said second data structure stored in a second data source simultaneously accessible by a second plurality of users, said second data structure defining a hierarchy location field containing, for each record, a corresponding hierarchy location identifier indicative of a display location of data corresponding to a hierarchically displayable field of that record in a displayable hierarchical data structure;
displaying, to a first user, data corresponding to said hierarchically displayable field of said plurality of records according to said displayable hierarchical data structure;
while said displaying, to said first user, said data corresponding to said hierarchically displayable field of said plurality of records according to said displayable hierarchical data structure, simultaneously displaying, to said first user, said plurality of records according to a first display of said first data structure;
and
while said simultaneously displaying, automatically synchronizing changes, by said first user, to data corresponding to said hierarchically displayable field of any of said plurality of records between said first data structure and said second data structure.

2. The method of claim 1, further comprising:
displaying, to said first user, said plurality of records according to said first data structure.

3. The method of claim 1, further comprising:
while said simultaneously displaying, simultaneously displaying said plurality of records according to a second display of said first data structure.

4. The method of claim 1, further comprising:
automatically sorting said plurality of records without modifying said hierarchy location identifier associated with each of said records.

5. The method of claim 1, further comprising:
responsive to user input to said predetermined information device, automatically sorting said plurality of records without modifying said second data structure.

6. The method of claim 1, further comprising:
automatically sorting said plurality of records without modifying said first data structure.

7. The method of claim 1, further comprising:
automatically sorting said plurality of records of said first data structure in t first display of said first data structure without modifying a second display of said plurality of records said first data structure.

8. The method of claim 1, further comprising:
responsive to input by said first user to said predetermined information device, automatically changing the hierarchy location identifier for each of a first subplurality of records from said plurality of records, and automatically modifying said displayable hierarchical data structure according to said changed hierarchy location identifiers.

9. The method of claim 1, further comprising:
responsive to input by said first user to said predetermined information device, automatically changing the hierarchy location identifier for each of a first subplurality of records from said plurality of records, and, without modifying said first data structure, automatically modifying said displayable hierarchical data structure according to said changed hierarchy location identifiers.

10. The method of claim 1, further comprising:
causing data corresponding to said hierarchically displayable field of a first predetermined record to simultaneously appear, to said first user, in multiple display locations in said displayable hierarchical data structure.

11. The method of claim 1, further comprising:
responsive to input by said first user to said predetermined information device, without modifying said first data structure, causing data corresponding to said hierarchically displayable field of a first predetermined record to simultaneously appear, to said first user, in multiple display locations in said displayable hierarchical data structure.

12. The method of claim 1, further comprising:
responsive to input by said first user to said predetermined information device, automatically hiding descendants of a second predetermined record from displaying, to said first user, in said displayable hierarchical data structure.

13. The method of claim 1, further comprising:
responsive to input by said first user to said predetermined information device, without modifying said first data structure, automatically hiding descendants of a second predetermined record from displaying, to said first user, in said displayable hierarchical data structure.

14. The method of claim 1, further comprising:
responsive to input by first user to said predetermined information device, automatically causing descendants of a second predetermined record to display, to said first user, in said displayable hierarchical data structure.

15. The method of claim 1, further comprising:
based on criteria provide by said first user, preventing a second subplurality of said records from displaying, to said first user, in said displayable hierarchical data structure.

16. The method of claim 1, further comprising:
based on criteria provided by said fist user, without modifying said first data structure, preventing a second subplurality of said records from displaying, to first user in said displayable hierarchical data structure.

17. The method of claim 1, further comprising:
responsive to a selection, by said first user, of the hierarchically displayable field of a predetermined record, activating a script.

18. The method of claim 1, further comprising:
responsive to selection, by said first user, of the hierarchically displayable field of a predetermined record, without modifying said first data structure, activating a script.

19. The method of claim 1, further comprising:
based on a criteria specified by said first user, filtering said plurality of records.

20. The method of claim 1, further comprising:
based on a criteria specified by said first user, without modifying said first data structure, filtering said plurality of records.

21. The method of claim 1, wherein:
said synchronizing occurs automatically upon entry of any of said changes by said first user.

22. A machine-readable medium comprising machine-implementable instructions for activities comprising:
from a first data source that is simultaneously accessible by each of a first plurality of users, said first data source comprising a first data structure comprising a plurality of records comprising data organized by a plurality of fields, determining a second data structure based on an automatic analysis of each record of the plurality of records, said second data structure stored in a second data source simultaneously accessible by a second plurality of users, said second data structure defining a hierarchy location field containing, for each record, a corresponding hierarchy location identifier indicative of a display location of data corresponding to a hierarchically displayable field of that record in a displayable hierarchical data structure;
displaying, to a first user, data corresponding to said hierarchically displayable field of said plurality of records according to said displayable hierarchical data structure;
while said displaying, to said first user, said corresponding to said hierarchically displayable field of said plurality of records according to said displayable hierarchical data structure, simultaneously displaying, to said first user, said plurality of records according to a first display of said first data structure; and
synchronizing changes to data corresponding to said hierarchically displayable field of any of said plurality of records between said first data structure and said second data structure.

23. A circuit comprising:
a hierarchy processor of a predetermined information device, said hierarchy processor adapted for:
automatically synchronizing changes to data corresponding to a hierarchically displayable field of any of a plurality of records between a first data structure and a second data structure, said data simultaneously displayed, to a first user, according to a displayable hierarchical data structure and a play of said first data structure, said first data structure comprised by a first data source that is simultaneously accessible by each of a first plurality of users, said first data structure comprising said plurality of records, said second data structure based on an automatic analysis of each record of the plurality of records, said second data structure stored in a second data source simultaneously accessible by a second plurality of users, said second data structure defining a hierarchy location field containing, for each record, a corresponding hierarchy location identifier indicative of a display location of data corresponding to said hierarchically displayable field of that record in said displayable hierarchical data structure.
